(19) United States
(12) Patent Application Publication
(10) Pub. No.: US 2025/0010840 A1
(43) Pub. Date: Jan. 9, 2025

(54) METHOD FOR ACTIVATING A SENSOR SYSTEM, SENSOR SYSTEM, VEHICLE, COMPUTER PROGRAM PRODUCT, AND STORAGE MEDIUM

(71) Applicant: HELLA GmbH & Co. KGaA, Lippstadt (DE)

(72) Inventors: Nils LABAHN, Lippstadt (DE); Andreas MUELLER, Bueren OT Siddinghausen (DE)

(73) Assignee: HELLA GmbH & Co. KGaA, Lippstadt (DE)

(21) Appl. No.: 18/892,924

(22) Filed: Sep. 23, 2024

Related U.S. Application Data
(63) Continuation of application No. PCT/EP2023/056214, filed on Mar. 10, 2023.

(30) Foreign Application Priority Data
Mar. 22, 2022 (DE) 10 2022 106 664.9

(51) Int. Cl. B60T 17/22; G07C 5/08

(52) U.S. Cl. CPC B60T 17/221; G07C 5/0808

(57) ABSTRACT

A sensor system and method for activating the sensor system for transmitting at least one item of first sensor information from a first sensor channel to a first central processing unit and at least one item of second sensor information from a second sensor channel to a second central processing unit. At least one first quality value is determined relating to the functional quality of the first sensor channel at a first control unit on the basis of the first sensor information via the first central processing unit. At least one second quality value is determined relating to the functional quality of the second sensor channel at a second control unit on the basis of the second sensor information via the second central processing unit. A comparison is performed of the first quality value and the second quality value. The sensor system is activated based on the comparison.

This nonprovisional application is a continuation of International Application No. PCT/EP2023/056214, which was filed on Mar. 10, 2023, and which claims priority to German Patent Application No. 10 2022 106 664.9, which was filed in Germany on Mar. 22, 2022, and which are both herein incorporated by reference.

### BACKGROUND OF THE INVENTION

### Field of the Invention

The present invention relates to a method for activating a sensor system, as well as to a sensor system for carrying out the method. The invention further relates to a vehicle with such a sensor system, in particular as part of or in the form of a braking system for braking the vehicle, a computer program product for carrying out such a method, and a storage medium on which such a computer program product is stored.

### Description of the Background Art

Various sensor systems are known in the conventional art. Sensor systems of the generic type have multiple sensors and/or sensor channels for determining and transmitting sensor information. The determined sensor information can be sent to a central control unit or to different control units. An actuator system, which ultimately executes desired operations, can be driven by means of the control units. The actuator system can be provided as part of a control unit or as a distributed entity. Such a control system can be designed in the form of a braking system or as part of a braking system for a vehicle. In modern electric braking systems, so-called “true brake-by-wire” systems, in which an all-electric brake pedal is used, are being installed in the meantime. A mechanical fallback solution or a mechanical bypass by the driver in the case of a fault is no longer present or possible. Since the braking function in a vehicle is system-relevant in nearly every operating state, the braking system cannot simply be switched off in the event of a detected fault, but should instead always remain operable. In order to ensure this, redundantly constructed braking systems are known. For example, a device and method for fault detection in electronic brake pedals are described in the German patent application DE 199 20 850 A1 for this purpose.

Owing to the redundant systems in the automotive field, as a rule a so-called “fail-safe” is sufficient. Three diverse-redundant systems, as they are known from aviation for so-called “fail-operational methods,” are not used in the automotive field or are not as yet practicable and are too expensive there on account of mechanical limitations. Nevertheless, in modern brake-by-wire systems it is desirable that possible faults can be identified still more reliably, and that a driver's braking command can be deduced on the basis of the available information even when a fault is present, without violating the safety goals. This should also be considered against the background that it is not always possible to rule out the existence of common cause faults, which is to say faults that affect more than one signal at the same time.

In known sensor systems, for example in the form of a vehicle braking system, it can happen that a sensor signal of a displacement sensor and/or of a force sensor no longer arrives at one of the two control units or only arrives overlaid with interfering signals. Moreover, it is possible that the evaluations carried out in the two control units of a synchronism between displacement sensor signals and force sensor signals, which should actually be expected on the basis of validity considerations, turn out differently in the control units. This means that the quality or the suitability and/or trustworthiness of the sensors or the sensor channels at the control units for driving the brake actuators may differ.

### SUMMARY OF THE INVENTION

It is therefore an object of the present invention to at least partially take into account the problems described above. In particular, it is an object of the present invention to create, in the simplest way possible, a correspondingly improved sensor system and a method for activating such a sensor system.

Of course, features that are described in connection with the method also apply in connection with the sensor system according to the invention, the vehicle according to the invention, the computer program product according to the invention, the storage medium according to the invention, and vice versa in each case, so mutual reference is and/or can always be made with regard to the disclosure of the individual aspects of the invention.

According to a first aspect of the present invention, a method for activating a sensor system, in particular for a braking system of a motor vehicle, is proposed. The sensor system includes at least one first sensor channel, at least one second sensor channel that is redundant with respect to the first sensor channel, at least one first control unit with a first central computing unit, at least one second control unit that is redundant with respect to the first control unit with a second central computing unit that is redundant with respect to the first central computing unit, and at least one evaluation unit. The method has the following steps: sending at least one first item of sensor information from the first sensor channel to the first central computing unit, sending at least one second item of sensor information from the second sensor channel to the second central computing unit, determining, by means of the first central computing unit, at least one first quality value relating to the functional quality of the first sensor channel at the first control unit on the basis of the first item of sensor information, determining, by means of the second central computing unit, at least one second quality value relating to the functional quality of the second sensor channel at the second control unit on the basis of the second item of sensor information, carrying out a comparison, by means of the evaluation unit, of the first quality value and the second quality value, and activating the sensor system on the basis of the comparison.

By applying the method according to the invention, different sensor signals, or the resultant sensor information, from the same and different sources can be validated against one another in order to deduce therefrom how reliable and/or trustworthy the sensor system is, so as to activate the sensor system on this basis in turn. In comparison with conventional methods, in this method it is not only determined whether a sensor channel, a control unit, and/or the sensor channel at the control unit is functional or not, but also what quality the sensor channel at the control unit has, which is to say how reliably a sensor information transmission is functioning and/or how trustworthy the transmitted sensor information items are, for example. Based on such a foundation of data, the sensor system can be activated in an especially stable and, above all, reliable manner without a need for an appreciable expansion of the hardware.

The sensor system can have at least one activating unit for a mechanical and/or electrical activation, and at least one actuator for driving the activating unit, wherein the actuator and/or the activating unit can be driven and/or activated to activate or operate the sensor system on the basis of the comparison. This means that the activating unit can be driven as a function of the quality values that are determined, by which means the sensor system is correspondingly activated. The sensor system can therefore be understood not only as a system with sensors and/or sensor channels, but rather as an electrical and/or mechanical activating system with the sensor arrangement according to the invention. Thus, the sensor system can be configured and designed as, e.g., the initially mentioned braking system for a vehicle in which at least one wheel brake of the braking system can be activated differently, which is to say with different use of the control units, on the basis of the comparison or dependent upon the quality values determined.

The activating of the sensor system can be a running and/or operating of the sensor system, in particular the performing of the primary task of the sensor system. In the case of the braking system, the primary task would be activating or releasing at least one wheel brake or operating the wheel brake and/or a signal transmission between brake pedal sensor unit and wheel brake. Activating can accordingly also be understood as an intentional non-activation of the sensor system so that the wheel brakes are intentionally not activated and/or are driven correspondingly, for example. The sensor system can be understood as a true brake-by-wire system, in particular. In a broader sense, however, the system can also be understood as a fail-operational sensor system, which is to say a sensor system that is not or must not be automatically switched off when a fault is detected, but instead continues to be or should continue to be operated.

The sensor system can have at least one first sensor with multiple sensor channels and at least one second sensor with multiple sensor channels. The sensor channels of the respective sensors preferably have a signal connection to the different control units. This means that a first sensor channel of the first sensor can have a signal connection to the first control unit, and a second sensor channel of the first sensor can have a signal connection to the second control unit. A first sensor channel of the second sensor can have a signal connection to the first control unit, and a second sensor channel of the second sensor can have a signal connection to the second control unit. In analogous fashion, additional sensor channels of the two sensors and/or additional sensor channels of additional sensors can have a signal connection to the two control units and/or to additional control units. For the simplest possible readability, the term “at least one” is only mentioned initially in most cases in the present text, but should nevertheless be considered as included according to the customary understanding of a person skilled in the art.

A sensor can be a brake pedal sensor or a brake pedal sensor unit, which in turn can have at least two additional diverse sensors. These sensors can have a pedal travel sensor that measures inductively and a force simulation sensor that measures magnetically. Each of these sensors can now have at least two sensor channels, preferably four or more sensor channels. If a driver's braking command is applied through an activation of the brake pedal sensor, corresponding sensor signals or sensor information items are generated that are forwarded to the respective computing units over the sensor channels. On the basis of the sensor information items, the quality values described above can now be determined by means of the computing unit or by means of the at least one central computing unit. Subsequently the sensor system can be activated with the use of the quality values or the comparison. In this way it is possible to prevent, for example, that an activation of the wheel brake is undertaken with an excessively long or an excessively short delay or that the activation of the wheel brake is not even possible at all. The above-described actuators can be viewed as part of the control units or as part of the wheel brake and/or be located correspondingly. In the case of an electromechanical wheel brake, it is possible, for example, that the control units only ascertain the braking command, transmit it to the wheel brakes, and the actuators are located directly there.

The first control unit and the second control unit can have a signal connection to one another, for example through a CAN bus of the sensor system. The first quality value determined by the first central computing unit and the second quality value determined by the second central computing unit can be exchanged between the two control units over such a signal connection in order to make the comparison. This means that the first quality value and the second quality value can be compared with one another or a corresponding synchronism can be determined in both control units or even in only one control unit.

The comparison can be an employing and/or taking into consideration of the first quality value and the second quality value with reference to one another. In this process, for example, an arithmetic operation can be carried out using the first quality value and the second quality value to obtain at least one overall quality value, wherein the sensor system can be activated on the basis of the overall quality value. Each quality value can be understood as quality information with multiple quality values.

It is possible that the comparison is carried out with the use of a value matrix. In tests within the scope of the present invention, a value matrix proved to be an especially simple but nevertheless effective means for reliably determining the most meaningful possible relationships between the first quality value and the second quality value. The sensor system can be activated or used correspondingly reliably with the use of the value matrix. The first quality value or first quality values that are derived from first control information items and the second quality value or second quality values that are derived from second control information items can be compared in the value matrix. In this, way a corresponding quality status can be determined continuously for each control unit and/or for each sensor channel at the control unit.

Furthermore, it is possible in a method according to the invention that at least one overall quality value relating to the first sensor channel at the first control unit and to the second sensor channel at the second control unit is determined on the basis of the comparison, and the sensor system is activated on the basis of the overall quality value. This means that an overall quality value relating to the overall functional quality of the sensor channels at the control units can be determined as a function of the quality values compared in each case, or as a function of corresponding value pairings. The sensor system can be activated or operated on the basis of or taking into consideration the overall quality value. As a result, the sensor system can be reliably activated with especially little computational effort.

In a method according to the invention, it is additionally possible that the first quality value and/or the second quality value are each determined from a spectrum of quality values that has more than two different quality values. This means that it is not only determined whether a control unit and/or a sensor channel at the control unit is functioning or not functioning or whether a signal can be communicated or not, but also the quality with which the respective control unit and/or the respective sensor channel at the respective control unit is functioning. The quality spectrum can have a value range between 1 and 5, from 0 to 7, or a significantly larger and/or more finely graduated range, for example. Thus, the first quality value can be 2 and the second quality value 7, for example, wherein a comparison produces an overall quality value of 4, wherein 0 is very bad and 7 is very good. As a result, a quality graduation of nearly any desired fineness can be achieved, depending on the existing or possible computing power as well as the desired results. Consequently, correspondingly meaningful characteristic values can be obtained, with the use of which the sensor system can be reliably operated in a simple manner.

It is possible in a method according to the invention that a relative quality assessment between the first quality value and the second quality value is carried out on the basis of the comparison, and the sensor system is activated on the basis of the relative quality assessment. The relative quality assessment can be carried out quickly and with little computing power, and permits helpful statements and/or instructions, for example relating to which control unit in the sensor system should currently be used by preference and/or which processes should be carried out by which control unit. Stated simply, the relative quality assessment can be understood to mean how well one control unit functions in comparison with another control unit and/or how good the connection of one sensor channel at one control unit is in comparison with a connection of a different sensor channel at a different control unit. Consequently, it is possible in a method according to the present invention that a master/slave dependency between the first control unit and the second control unit is adjusted and/or changed as a function of the relative quality assessment. As a result, a correspondingly advantageous flexibility in the reliable employment of the functional components that are present, in particular in the employment of the control units, can be achieved in a simple manner. If specific and/or predefined quality value pairings arise, it is possible, for example, to switch from the first control unit to the second control unit as master, namely in a timely manner before the first control unit potentially fails.

In a method according to the invention, furthermore, a warning signal that is perceptible to a user of the sensor system can be emitted on the basis of the comparison or on the basis of the first quality value and the second quality value. With respect to the exemplary braking system, for example, an acoustic, visual, and/or haptic warning can be emitted to a vehicle occupant in a vehicle with the braking system in the event of specific or predefined value pairings or in the event of a specific or predefined overall quality value. The warning can include a notification that the vehicle should only be driven a specific remaining distance and/or an emergency operation will be or can be started, for example. In this way, the method helps to improve safety for a user of the sensor system and/or of the method, in particular.

The sensor system can have an activating unit, the first control unit can have a first actuator, and the second control unit can have a second actuator that is redundant with respect to the first actuator, wherein a method according to the invention can be modified to the effect that the activating unit is activated by the first actuator and/or by the second actuator on the basis of the comparison. Accordingly, an actuator system of the control units can be driven in a correspondingly efficient and fail-safe manner by means of the method.

Still further, it is possible in a method according to the present invention that the first quality value and the second quality value are communicated to at least one path selector of the first control unit and/or of the second control unit, wherein a signal path through the first control unit and/or through the second control unit for activating the sensor system is chosen by the path selector on the basis of the first quality value and/or on the basis of the second quality value. By means of the signal path determination according to the invention, the sensor system can be operated in a relatively simple but nevertheless reliable manner with high failure safety.

The sensor system can furthermore have at least one deviation information computing unit, wherein, within the scope of a method according to the invention, at least one item of deviation information between the first item of sensor information and the second item of sensor information is calculated by means of the deviation information computing unit, and the first quality value and/or the second quality value are determined on the basis of the deviation information. The quality values can be determined quickly, simply, and meaningfully on the basis of deviation information, which should not be understood as information to be used solely for determining the quality values. Consequently, the sensor system can be activated correspondingly advantageously or the method can be carried out correspondingly advantageously on the basis of the deviation information that is determined and used. Each deviation information computing unit is preferably provided as part of a respective central computing unit and/or of a respective control unit. The item or items of deviation information can, in particular, be calculated based on the first item of sensor information and the second item of sensor information. This means that items of deviation information can also be calculated between information items and/or values that have been further developed and/or calculated on the basis of the first item of sensor information and the second item of sensor information.

According to another aspect of the present invention, a sensor system, in particular for a braking system of a motor vehicle, is proposed. The sensor system includes: at least one first sensor channel, at least one second sensor channel that is redundant with respect to the first sensor channel, at least one first control unit with a first central computing unit, wherein the first sensor channel is configured to send at least one first item of sensor information from the first sensor channel to the first central computing unit, and the first central computing unit is configured to determine at least one first quality value relating to the functional quality of the first sensor channel at the first control unit on the basis of the first item of sensor information, at least one second control unit that is redundant with respect to the first control unit with a second central computing unit that is redundant with respect to the first central computing unit, wherein the second sensor channel is configured to send at least one second item of sensor information from the second sensor channel to the second central computing unit, and the second central computing unit is configured to determine at least one second quality value relating to the functional quality of the second sensor channel at the second control unit on the basis of the second item of sensor information, at least one evaluation unit for carrying out a comparison of the first quality value and the second quality value, and a processing unit for processing the comparison for an activating of the sensor system.

As a result, the sensor system according to the invention offers the same advantages as have been described in detail in relation to the method according to the invention. A sensor system for a braking system can be understood, for example, as a sensor system for use in the braking system, by means of which the main functions of the braking system preferably are realized. Furthermore, the sensor system can also be configured as a braking system as described above for a vehicle. This means that the sensor system can be a braking system having the sensor system. The central computing unit can have a quality value computing unit in each case for determining the respective quality value. The phrase ‘the processing unit is configured for processing the comparison for an activating of the sensor system’ can be understood to mean that the processing unit or a part of the processing unit helps to activate the sensor system and/or to operate the braking system.

The sensor system can be configured and designed to carry out a method as described above in detail. For this purpose, a value matrix as described above with a suitable spectrum of quality values can be or become implemented in the sensor system. A master/slave relationship can be or become established between the first control unit and the second control unit. The control units and/or an additional computing unit of the sensor system can be configured to autonomously change the master/slave relationship. The sensor system can furthermore have a signal emitting unit for emitting a warning signal according to the invention. In order to carry out a method according to the invention, the sensor system can further have an activating unit, the first control unit can have a first actuator, and the second control unit can have a second actuator that is redundant with respect to the first actuator, wherein the first actuator and/or the second actuator are configured to activate the activating unit on the basis of the comparison. An activation of the activating unit can be understood in the present case as, for example, the activating of an activating unit in the form of a wheel brake, which is to say a transmission of force to the wheel brake. The first control unit can have a path selector. Alternatively or in addition, the second control unit can have a, or a second, path selector, wherein the sensor system can be configured such that the first quality value and the second quality value are communicated to the path selector of the first control unit and/or of the second control unit. By means of the at least one path selector, a signal path through the first control unit and/or through the second control unit can be selected in each case on the basis of the first quality value and/or on the basis of the second quality value in order to activate the sensor system or operate it correspondingly.

Moreover, the sensor system can have at least one deviation information computing unit, wherein this unit can be configured to calculate at least one item of deviation information between the first item of sensor information and the second item of sensor information. The central computing unit and/or the quality value computing unit can each be configured to determine the first quality value and/or the second quality value on the basis of the deviation information.

Another aspect of the present invention relates to a vehicle with a braking system for braking the vehicle, wherein the braking system has a sensor system as described above. As a result, the vehicle according to the invention also offers the above-described advantages. The vehicle can be a road vehicle such as a truck or a car, wherein the vehicle can also be a watercraft, an aircraft, a rail vehicle, or a robot.

The invention additionally relates to a computer program product comprising statements that cause a sensor system as described above to carry out the method steps described above. In addition, a computer-readable, in particular non-volatile, storage medium is proposed, on which such a computer program product is stored. As a result, the computer program product and the storage medium likewise offer the above-described advantages.

The computer program product can be implemented as computer-readable instruction code in any suitable programming language and/or machine language such as in Java, C++, C#, and/or Python, for example. The computer program product can be stored on a computer-readable storage medium such as a data disk, a removable drive, a volatile or nonvolatile memory, or a built-in memory/processor. The instruction code can program a computer or other programmable devices such as one or more control units in such a manner that the desired functions are executed. Furthermore, the computer program product can be provided in a network such as the Internet, for example, from which it can be downloaded by a user as needed. The computer program product can be realized by means of software as well as by means of one or more special electronic circuits, which is to say in hardware, or in any desired hybrid form, which is to say by means of software components and hardware components.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a sensor system according to an example of the present invention,

FIG. 2 shows a central computing unit according to the invention of the illustrated sensor system,

FIG. 3 shows a value matrix for calculating quality values in a sensor system according to the invention,

FIG. 4 shows a graph for explaining the calculation of an item of deviation information,

FIG. 5 shows a storage medium according to the invention with a computer program product stored thereon,

FIG. 6 shows a vehicle according to the invention with a braking system that includes the sensor system shown in FIG. 1, and

FIG. 7 shows a flowchart for explaining a method according to the invention.

### DETAILED DESCRIPTION

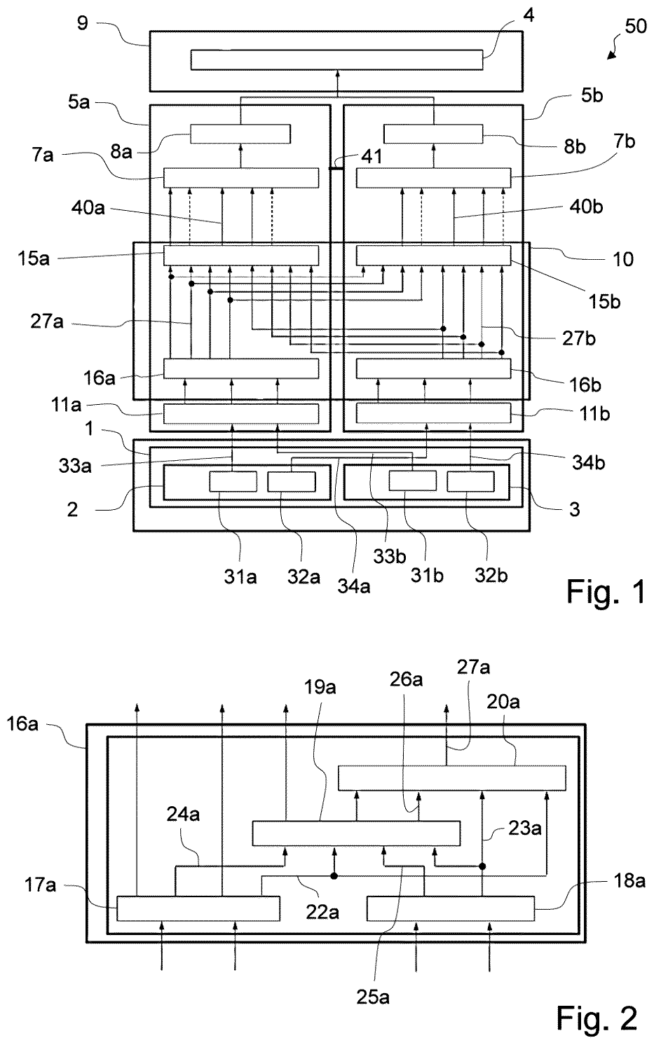

FIG. 1 shows a sensor system 50 for an electrical braking system of a motor vehicle 100 that is depicted in FIG. 6. The sensor system 50 is configured, in particular, for fault detection and fault diagnosis in the braking system as well as for activating the braking system as a function of the fault detection and fault diagnosis performed. The sensor system 50 has a brake pedal sensor unit 1 with a pedal travel sensor 2 and a force simulation sensor 3. The pedal travel sensor 2 has a first sensor channel 31a and a second sensor channel 32a that is redundant with respect to the first sensor channel 31a. The force simulation sensor 3 likewise has a first sensor channel 31b and a second sensor channel 32b that is redundant with respect to the first sensor channel 31b.

The sensor unit 50 that is shown has a first control unit 5a with a first central computing unit 16a, wherein the first sensor channel 31a, 31b is configured in each case to send first items of sensor information 33a, 33b from the respective first sensor channel 31a, 31b to the first central computing unit 16a. The sensor unit 50 further has a second control unit 5b that is independent and redundant with respect to the first control unit 5a, with a second central computing unit 16b that is redundant with respect to the first central computing unit 16a, wherein the second sensor channel 32a, 32b is configured in each case to send second items of sensor information 34a, 34b from the second sensor channel 32a, 32b to the second central computing unit 16b. The first control unit 5a has a first evaluation unit 15a, and the second control unit 5b has a second evaluation unit 15b that is redundant with respect to the first evaluation unit 15a. The central computing units 16a, 16b and the evaluation units 15a, 15b can be viewed as components of a higher-level processing unit 10. The two control units 5a, 5b each additionally have a first braking command computing unit 7a or a second braking command computing unit 7b as well as a first actuator 8a or a second actuator 8b. By means of the actuators 8a, 8b, an activating force 4 can be transmitted to an activating unit 9, which in the present case is designed in the form of a wheel brake. In other words, the activating unit 9 can be driven correspondingly by the actuators 8a, 8b. The evaluation units 15a, 15b, each of which can also be referred to as a path selector, are not both absolutely necessary. It is also possible that an evaluation unit 15a, 15b is implemented in only one primary control unit 5a, 5b. This could be useful when, for example, a secondary control unit 5a, 5b is supposed to have a reduced functional scope, for example because an actuator 8a, 8b is designed only for a relatively short period of operation.

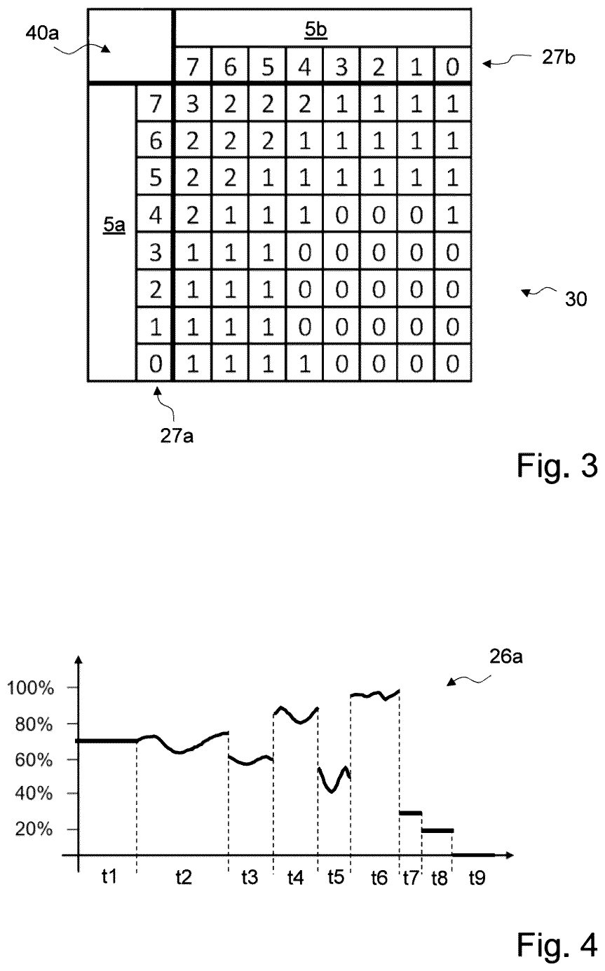

The sensor system 50 shown in FIG. 1 is depicted in FIG. 2 in further detail. FIG. 2 shows, in particular, additional possible and preferred functional components of the first central computing unit 16a. A detailed depiction and description of the analogously constructed second central computing unit 16b has been dispensed with to avoid a needlessly lengthy description. The first central computing unit 16a shown has a pedal travel sensor computing unit 17a and a force simulation sensor computing unit 18a, a deviation information computing unit 19a, and a quality value computing unit 20a. The quality value computing unit 20a is configured to determine quality values 27a or first quality values 27a relating to the functional quality of the first sensor channel 31a, 31b at the first control unit 5a on the basis of the first item of sensor information 33a, 33b. By means of a second quality value computing unit of the second central computing unit 16b, second quality values 27b relating to the functional quality of the second sensor channel 32a, 32b at the second control unit 5b can be determined in an analogous manner on the basis of the second item of sensor information 34a, 34b. The evaluation units 15a, 15b are each configured to carry out comparisons of the first quality values 27a and the second quality values 27b, shown in FIG. 3 and explained in detail further below. The sensor system 50 or the braking system shown in the figures can be operated on the basis of the comparison.

The control units 5a, 5b also have a first input signal diagnostic unit 11a or a second input signal diagnostic unit 11b in addition to the optional actuators 8a, 8b of a first braking command computing unit 7a or of a second braking command computing unit 7b. In order to increase the availability and/or functionality of the overall system for implementing the braking command, in the event of a fault in a control unit 5a, 5b, the entire control unit 5a, 5b is not switched off, depending on the fault, but instead only the functional group concerned. Thus, for example, a case is possible in which faults occur in the actuator 8b of the second control unit 5b and in the sensor channel 31a of the pedal travel sensor 2, which sends the sensor information to the first control unit 5a. In conventional systems in this case, both control units 5a, 5b would be affected by a fault and could not fulfill their function or could not fulfill it as desired. In the proposed sensor system, however, methods can now be employed, in particular when the affected sensor channel 31a is not simply switched off but instead provides an erroneous signal, that detect the presence of a fault in the sensor signal and subsequently switch over to sensors that can best accommodate the driver command. In the present case, this function is located in the processing unit 10, in particular in the respective central computing unit 16a, 16b there.

In the example shown, it can be assumed that wanted signals such as a driving signal, a status signal, and/or signals such as path signals relating to information as to which control unit the sensor information is used by, are defined as initial quantities for the processing unit. A confidence level concerning the correctness of the sensor signals can be described by the status signal. By means of the status signal, functional units in the control units 5a, 5b can therefore decide the degree to which fault responses are initiated or not, for example.

The central computing unit 16a shown in FIG. 2 has a pedal travel sensor computing unit 17a, which checks preprocessed raw signals from the first input signal diagnostic unit 11a for presence, and also performs a synchronism monitoring for the case that more than one signal is made available. Pedal travel sensor diagnostic information 22a that has been further processed is output by the pedal travel sensor computing unit 17a to the deviation information computing unit 19a and to the quality value computing unit 20a. Furthermore, general pedal travel sensor information 24a is output to the deviation information computing unit 19a and to the quality value computing unit 20a. The central computing unit 16a additionally has a force simulation sensor computing unit 18a, which processes preprocessed raw signals from the first input signal diagnostic unit 11a in an analogous or identical manner, and develops or determines force simulation sensor diagnostic information 23a and force simulation sensor information 25a therefrom. The force simulation sensor diagnostic information 23a and the force simulation sensor information 25a are likewise sent to the deviation information computing unit 19a and to the quality value computing unit 20a. The deviation information computing unit 19a is configured to calculate deviation information 26a between the first item of sensor information 33a and the second item of sensor information 34a, which are explained in further detail later with reference to FIG. 4.

The calculation of the deviation information 26a can be understood as a synchronism monitoring, which is carried out in the deviation information computing unit 19a but usually with greater complexity than in the pedal travel sensor computing unit 17a and/or in the force simulation sensor computing unit 18a, since it can be advantageous with regard to the functional safety at the overall system level that the sensor arrangement of the brake pedal sensor unit, which is to say in the present case the pedal travel sensor 2 and the force simulation sensor 3, measures different measured quantities. In this process, calibration tables can be used so that the functional relationship of the measured quantities in a “correctly functioning case” is constant with greatest possible reproducibility. The deviation information 26a between pedal travel sensor information 24a and force simulation sensor information 25a can be determined or calculated on this basis. The deviation information 26a calculated in each case can be added to a predefined or predefinable initial value, for example 70%. It is already possible to assess what possible failure effect is present on the basis of the deviation information 26a, in particular on the basis of a magnitude of the respective deviation information 26a and/or a direction of the respective deviation information 26a. For the case that one of the two input quantities for the synchronism is not present, it can be useful to set the respective deviation information 26a to a predefined value in order to nonetheless identify it as reliably as possible and in order to prevent a violation of a number space.

Pedal travel sensor diagnostic information 22a, force simulation sensor diagnostic information 23a, and deviation information 26a can be transmitted to the higher-level quality value computing unit 20a. In this unit, the information can be translated into a quality status, or determined or calculated as quality values, for example by means of status tables and/or mathematical functions, by computing units. In FIG. 2, a corresponding first quality value 27a is determined accordingly. On the basis of the quality values 27a, 27b, it is possible to deduce or determine how reliable and/or trustworthy the sensor information items at the respective control unit 5a, 5b are. Diagnostic limits can be taken into account in this process, as well.

A value matrix 30, which is used for the comparison described above, is explained with reference to FIG. 3. The number of quality levels can usefully be chosen with the number of existing sensor channels taken into account. In the present case, a graduation from 0 to 7 is chosen in each case. The absence of all information is assessed as the worst state at 0 and as a counterpart for the worst sensor value. In order to increase the availability and thus the failure safety, the quality value 27a, 27b of each and every control unit 5a, 5b is used on an overall basis with reference to both control units 5a, 5b. In the present example, the signals to be exchanged are exchanged between the control units 5a, 5b through a communication line 41, which comprises, for example, a bus and/or Ethernet. Depending on signal propagation times in the transmission, the directly available signals in the respective control unit 5a, 5b are to be preferred in the normal case, since this promises lower signal latency, and thus a response to the driver command that is as direct as possible. As shown in FIG. 3, the quality values 27a, 27b are compared and evaluated with regard to their severity or the remaining functionality in order to thus make a statement about the overall confidence level for the brake pedal sensor unit 1 in the form of the overall quality value 40a or corresponding values and/or information items. In the present value matrix shown by way of example, this is divided into four stages between 3 (everything is functioning correctly) and 0 (the sensor signals cannot be trusted because, for example, they contradict one another). In the case of a poor assessment of 1 or even 0, compensating measures can or should be taken. However, the compensating measures can or must be taken even in the case of deviations from relatively high quality values, wherein the permissible time duration depends strongly on the individual case. Any measures can be initiated, and/or appropriately taken into account, e.g., in the form of a user notification, within months (for example at the next customer service) for a 2, within hours for a 1, and immediately for a 0, for example within approximately 450 ms in the case of a brake system. The intermediate levels make it possible to provide notification of faults, and, depending on severity, even to initiate preventive protective functions as well.

FIG. 4 shows a graph for explaining the calculation of a deviation information item as mentioned above. According to the graph depicted in FIG. 4, an initial value of 70% is predefined. At the start, in the time window t1, a perfect—and in practice improbable-situation exists, in which the pedal travel sensor information 24a and the force simulation sensor information 25a (subsequently referred to in simplified terms as “signal information items”) are available and there is no deviation between the signal information items. Subsequently, in the time window t2, a situation exists that is typical in practice, in which both signal information items are available and a slightly fluctuating deviation exists between the signal information items. In the time windows t3, t4, t5, and t6, both signal information items are indeed available, but the deviations between the signal information items are too high so that countermeasures that are appropriate in each case would have to be taken, or at least should be taken. In the time windows t3 and t5, a braking pressure that is possibly too low can be expected, and in the time windows t4 and t6 a braking pressure that is possibly too high can be expected. In the time window t7, the signal information is based solely on a sensor signal of the pedal travel sensor 2. In the time window t8, the signal information is based solely on a sensor signal of the force simulation sensor 3. In the time window t9, the worst case exists, in which no signal information items are present or can be detected.

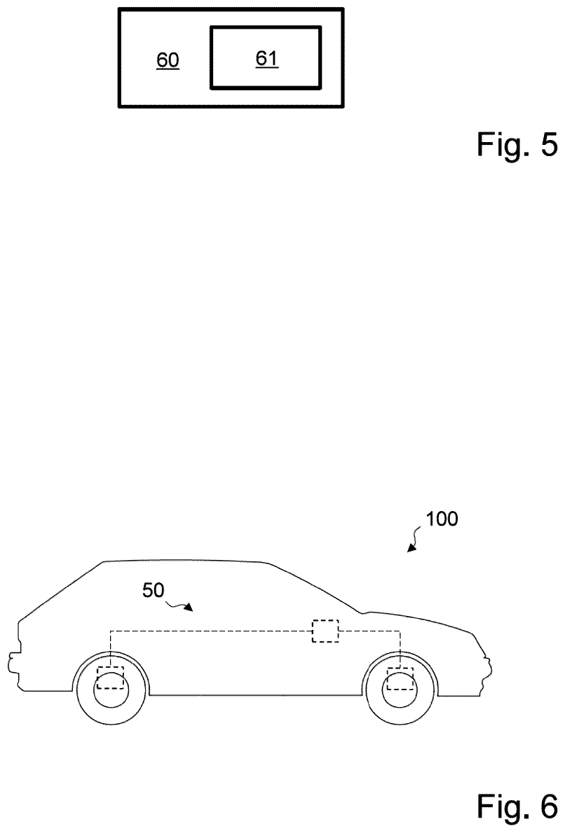

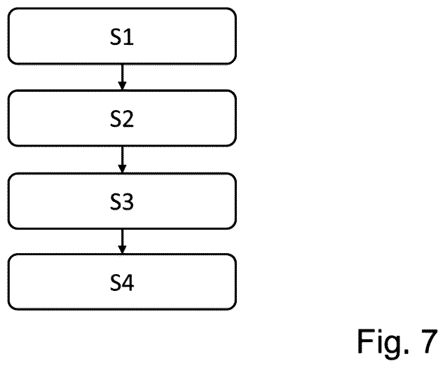

FIG. 5 shows a nonvolatile and computer-readable storage medium 60 with a computer program product 61 stored thereon. The computer program product 61 comprises statements that cause a sensor system 50 as described above, in particular in the form of a braking system, to carry out method steps that are explained later with reference to FIG. 7.

FIG. 6 shows a vehicle 100 in the form of an automobile that is equipped with a braking system for braking the vehicle 100, wherein the braking system has a sensor system 50 as described above.

A method for activating a sensor system 50 as described in detail above is explained with reference to the flowchart shown in FIG. 7. In a first step S1, to begin with, first items of sensor information 33a, 33b are sent from the first sensor channels 31a, 31b to the first central computing unit 16a. In addition, second items of sensor information 34a, 34b are sent from the second sensor channels 32a, 32b to the second central computing unit 16b. In a second step S2, first quality values 27a relating to the functional quality of the first sensor channels 31a, 31b at the first control unit 5a are determined by means of the first central computing unit 16a on the basis of the first items of sensor information 33a, 33b. In addition, second quality values 27b relating to the functional quality of the second sensor channels 32a, 32b at the second control unit 5b are determined by means of the second central computing unit 16b on the basis of the second items of sensor information 34a, 34b. In a third step S3, comparisons of the first quality values 27a with the second quality values 27b are carried out by means of the evaluation units 15a, 15b. In a fourth step S4, the sensor system 50 is activated, or the braking system is operated, on the basis of the comparison or comparisons.

The invention allows for additional design principles apart from the embodiments shown. In other words, the invention should not be viewed as being limited to the exemplary embodiments explained with reference to the figures.

Thus, it is possible within the scope of the method that the comparison is carried out with the use of the value matrix 30 and/or that at least one overall quality value 40a, 40b relating to the first sensor channel 31a, 31b at the first control unit 5a and to the second sensor channel 32a, 32b at the second control unit 5b is determined on the basis of the comparison, and the sensor system 50 is activated on the basis of the overall quality value 40a, 40b. It is furthermore possible that the first quality value 27a and/or the second quality value 27b are each determined from a spectrum of quality values that has more than two different quality values. A relative quality assessment between the first quality value 27a and the second quality value 27b can be carried out on the basis of the comparison, wherein the sensor system 50 can be activated on the basis of the relative quality assessment. A master/slave dependency between the first control unit 5a and the second control unit 5b can furthermore be adjusted and/or changed as a function of the relative quality assessment. Moreover, a warning signal that is perceptible to a user of the sensor system 50 can be emitted on the basis of the comparison. In addition, it is possible that the activating unit 9 is activated by the first actuator 8a and/or by the second actuator 8b on the basis of the comparison. The first quality value 27a and the second quality value 27b can be communicated to at least one evaluation unit 15a, 15b in the form of a path selector of the first control unit 5a and/or of the second control unit 5b, wherein a signal path through the first control unit 5a and/or through the second control unit 5b for activating the sensor system 50 can be chosen by the evaluation unit 15a, 15b on the basis of the first quality value 27a and/or on the basis of the second quality value 27b. At least one item of deviation information 26a between the first item of sensor information 33a, 33b and the second item of sensor information 34a, 34b can be calculated by means of the deviation information computing unit 19a, wherein the first quality value 27a and/or the second quality value 27b can be determined on the basis of the deviation information 26a.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for activating a sensor system for a braking system of a motor vehicle, the sensor system comprising at least one first sensor channel, at least one second sensor channel that is redundant with respect to the first sensor channel, at least one first control unit with a first central computing unit, at least one second control unit that is redundant with respect to the first control unit with a second central computing unit that is redundant with respect to the first central computing unit, and at least one evaluation unit, the method comprising:
sending at least one first item of sensor information from the first sensor channel to the first central computing unit;
sending at least one second item of sensor information from the second sensor channel to the second central computing unit;
determining, via the first central computing unit, at least one first quality value relating to the functional quality of the first sensor channel at the first control unit based on the first item of sensor information;
determining, via the second central computing unit, at least one second quality value relating to the functional quality of the second sensor channel at the second control unit based on the second item of sensor information;
performing a comparison, via the evaluation unit, of the first quality value and the second quality value; and
activating the sensor system based on the comparison.

2. The method according to claim 1, wherein the comparison is performed with the use of a value matrix.

3. The method according to claim 1, wherein at least one overall quality value relating to the first sensor channel at the first control unit and to the second sensor channel at the second control unit is determined on the basis of the comparison, and wherein the sensor system is activated on the basis of the overall quality value.

4. The method according to claim 1, wherein the first quality value and/or the second quality value are each determined from a spectrum of quality values that has more than two different quality values.

5. The method according to claim 1, wherein a relative quality assessment between the first quality value and the second quality value is carried out on the basis of the comparison, and wherein the sensor system is activated on the basis of the relative quality assessment.

6. The method according to claim 5, wherein a master/slave dependency between the first control unit and the second control unit is adjusted and/or changed as a function of the relative quality assessment.

7. The method according to claim 1, wherein a warning signal that is perceptible to a user of the sensor system is emitted on the basis of the comparison.

8. The method according to claim 1, wherein the sensor system has an activating unit, the first control unit has a first actuator, and the second control unit has a second actuator that is redundant with respect to the first actuator, and wherein the activating unit is activated by the first actuator and/or by the second actuator on the basis of the comparison.

9. The method according to claim 1, wherein the first quality value and the second quality value are communicated to at least one path selector of the first control unit and/or of the second control unit, and wherein a signal path through the first control unit and/or through the second control unit for activating the sensor system is chosen by the evaluation unit on the basis of the first quality value and/or on the basis of the second quality value.

10. The method according to claim 1, wherein the sensor system has at least one deviation information computing unit, wherein at least one item of deviation information between the first item of sensor information and the second item of sensor information is calculated by the deviation information computing unit, and the first quality value and/or the second quality value are determined on the basis of the deviation information.

11. A sensor system for a braking system of a motor vehicle, the sensor system comprising:
at least one first sensor channel;
at least one second sensor channel that is redundant with respect to the first sensor channel;
at least one first control unit with a first central computing unit, the first sensor channel being configured to send at least one first item of sensor information from the first sensor channel to the first central computing unit, and the first central computing unit being configured to determine at least one first quality value relating to the functional quality of the first sensor channel at the first control unit on the basis of the first item of sensor information;
at least one second control unit that is redundant with respect to the first control unit with a second central computing unit that is redundant with respect to the first central computing unit, the second sensor channel being configured to send at least one second item of sensor information from the second sensor channel to the second central computing unit, and the second central computing unit being configured to determine at least one second quality value relating to the functional quality of the second sensor channel at the second control unit on the basis of the second item of sensor information;
at least one evaluation unit for carrying out a comparison of the first quality value and the second quality value; and
a processing unit for processing the comparison to determine an activation of the sensor system.

12. The sensor system according to claim 11 that is configured and designed to carry out a method comprising:
sending at least one first item of sensor information from the first sensor channel to the first central computing unit;
sending at least one second item of sensor information from the second sensor channel to the second central computing unit;
determining, via the first central computing unit, at least one first quality value relating to the functional quality of the first sensor channel at the first control unit based on the first item of sensor information;
determining, via the second central computing unit, at least one second quality value relating to the functional quality of the second sensor channel at the second control unit based on the second item of sensor information;
performing a comparison, via the evaluation unit, of the first quality value and the second quality value; and
activating the sensor system based on the comparison.

13. A vehicle with a braking system for braking the vehicle, wherein the braking system has a sensor system according to claim 11.

14. A computer program product comprising instructions that cause a sensor system according to carry out the method according to claim 1.

15. A computer-readable storage medium having stored thereon the computer program product according to claim 14.
